(19) United States
(12) Patent Application Publication
(10) Pub. No.: US 2009/0047059 A1
(43) Pub. Date: Feb. 19, 2009

(54) BINDER APPARATUS

(76) Inventors: Douglas B. Davis, Port Carling (CA); Larry A. Morin, Newmarket (CA)

Correspondence Address: ORTIZ & LOPEZ, PLLC, P.O. BOX 4484, ALBUQUERQUE, NM, 87196-4484, US

(21) Appl. No.: 11/840,809

(22) Filed: Aug. 17, 2007

(51) Int. Cl. B42F 13/00; G09F 3/18

(52) U.S. Cl. 402/77; 40/642.02

(57) ABSTRACT

A double hinged binder includes a binder spine, a front flange, a front cover, a rear cover, each having a first and a second longitudinal edge, a label holder means provided on said binder spine and front flange and a plurality of rings disposed on the internal surface of the rear cover. The first longitudinal edge of the front flange is attached to the first longitudinal edge of the binder spine. The first longitudinal edge of the rear cover is attached to the second longitudinal edge of the binder spine. The first longitudinal edge of the front cover is attached to the second longitudinal edge of the front flange while the second longitudinal edge of the front cover is rotatably free. While the second longitudinal edge of the rear cover is rotatably free.

### FIELD OF THE INVENTION

Embodiments to binders as utilized in home, school, offices, industrial and other environments. Embodiments also relate to a double hinged ring binder. More particularly, embodiments relate to a double hinged ring binder that promotes space economy, enables customized wrap around templates, is easy to use and incorporates a predetermined quick loading ring metal.

### BACKGROUND OF THE INVENTION

Ring binders are generally used to hold punched sheets of paper by means of metal rings that run through holes punched into the sheets of paper. Ring binders conventionally known in the art have two to seven holes, which are used to maintain various stacks of paper. The more sheets of paper (thickness) the larger the capacity of the ring required to hold them.

Binders conventionally known in the art suffer from various disadvantages, particularly when used for holding a thick stack of paper. Binders having a large capacity for holding larger paper stacks, for example, would consequently be wider and thicker causing such binders to hang over the edge of storage shelves and take considerably more shelf space.

There is a need for a binder that enables customized wrap-around templates enabling the user to use these desired labels to easily identify the printed matter held within the binder. There are two main approaches to label vinyl binders which are predominantly used within the art, first being the method involving hand imprinting information on a small label identifying the printed matter on the binder spine and inserting it into a narrow pocket on the spine while the other approach involves securing a label on the binder spine using adhesives, clips etc.

It has been found that information imprinted on a binder spine identifying the printed matter held within the binder using these methods gradually wears off with time or permanently marks the binder ruling out any revision of the binder label, which is undesirable. Another problem with using adhesives, which is messy and subject to a gradual loosening of the adhesion with the passage of time.

A need exists for inexpensive, easy to apply labels that adhere well to the cover and are easily removable when required, while also not causing harm to the label holder. Commonly used spine labels include heat activated labels, foil back labels and paper labels. The heat activated labels typically constitute a plastic like material coated with a heat sensitive dry adhesive that melts when heated thereby permanently bonding to the material of the cover. The processing and application of such heat activated labels, however, is tedious and expensive.

Foil back labels currently known in the art essentially typically include an intermediate layer of paper laminated to a foil on the top surface and coated on the opposite surface with a pressure sensitive adhesive that bonds to the cover material. Such foil back labels, however are not suitable for laser printing applications and are not effective in providing customized spine labels.

Paper labels, though inexpensive, have declined in usage due to their limited capacity to adhere well to hard cover materials. The adhesives for attaching such labels to a binder cover, for example, can seep through the paper material and discolor the label with the passage of time. All these labels display what the contents are on the spine only.

There is thus a need for customizable spine labels that may be easily changed by a user depending upon the requirements or to reflect the type or classification of a document stack maintained within the binder and to identify the contents of the binder when placed closed on its back

Numerous attempts have been made in the present state of the art to address these and other problems but none have been found to adequately address the aforementioned requirements. Current binders do not address the need for enabling the use of customizable wrap around templates and/or avoiding the ink seepage through the label holder. Thus, there exists a need within the art for an improved binder that promotes space economy, enables the usage of customizable wrap around templates, while utilizing a predetermined quick loading ring metal and which is easy to use.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is therefore one aspect of the present invention to provide for an improved binder apparatus.

It is another aspect of the present invention to provide a binder that offers a high capacity for maintaining a thick stack of paper therein without extending over the edge of a storage shelf during storage of the binder.

It is a further aspect of the present invention to provide a binder having customized wrap around templates that enable a user to utilize desired labels that easily identify printed matter maintained by and within the binder.

It is a further aspect of the present invention to provide a binder wherein a binder label imprinted for the spine label holder does not wear off with time and does not permanently mark the spine label holder.

It is yet another aspect of the present invention to provide a binder having customizable spine labels that may be easily changed by a user depending upon the stack of paper held within the binder.

It is an additional aspect of the present invention to provide a binder wherein label ink does not seep through the label holder and therefore does not harm the material from which the label holder is configured.

It is a further aspect of the present invention to provide a ring binder that utilizes a predetermined quick loading ring metal and which is consequently easy to use.

The aforementioned aspects and other objectives and advantages can now be achieved as described herein. A binder apparatus is disclosed, which includes a double hinged cover that allows the binder to be made shorter in depth allowing for large capacity binders to fit on standard (e.g., 12″) office shelving. Previously binders of the same capacity would be much deeper in length causing them to hang over the edge of the shelving. This feature also makes the spine narrower which makes for easier handling and also requires less shelf width. The binder apparatus additionally includes a spine label holder that is attached at the rear cover seal of the spine and to the seal of the front flange and the front cover while leaving the spine seal in the center unsealed for the label holder. This feature allows the user to easily insert a label into the holder that not only appears on the spine but also wraps around to a portion of the front flange.

The binder apparatus is supported by a user friendly web-site that is configured to provide the user with a simple and easy way to create customizable labels from templates for insertion into the wrap-around label holder on the binder. The binder apparatus also can utilize clear vinyl PVC for the label holder which has been developed to minimize transfer of toner ink from the insert to the inside of the vinyl. This has been a common problem with the use of PVC and laser printed inserts. Additionally, the binder apparatus can utilize a newly developed ring metal that allows the user to more easily put paper onto the ring metal.

The binder apparatus thus includes a double hinged binder having a spine, a front flange, a front cover, a rear cover, a label holder on the spine and a plurality of rings disposed on the internal surface of the rear cover. The spine can be configured with an external surface and an internal surface defined by a first longitudinal edge and a second longitudinal edge. The front flange includes a first longitudinal edge and a second longitudinal edge. The first longitudinal edge of the front flange is generally attached to the first longitudinal edge of the spine. The second longitudinal edge of the front flange is attached to the first longitudinal edge of the front cover. The front cover has a first longitudinal edge and a second longitudinal edge.

The first longitudinal edge of the front cover is attached to the second longitudinal edge of the front flange while the second longitudinal edge of the front cover is rotatably free. The rear cover has a first longitudinal edge and a second longitudinal edge. The first longitudinal edge of the rear cover is attached to the second longitudinal edge of the spine while the second longitudinal edge of the rear cover is rotatably free. The label holder means is made up of a predetermined material and is adapted to overlie a portion of the binder spine and the front flange.

The portion of the label holder means overlying the binder spine and front flange is unattached to the external surface of the binder spine first longitudinal edge thereby defining a display area which is capable of receiving and displaying a label. The label has information displayed thereon. The label holder is attached to the outside surface at the first longitudinal edge of the rear cover and the first longitudinal edge of the front cover. The internal surface of the rear cover has a plurality of binder rings made up of a predetermined material. The binder rings run through a plurality of holes punched onto sheet material thereby holding the sheets of paper into the binder. The second longitudinal edges of the front and rear covers are rotatable from a first closed position to a second partially open or open position such that the longitudinal edges in the first closed position overlie each other thereby closing the binder. The longitudinal edges of the front and rear covers in the second partially opened or opened position allow access to the sheet material held within the binder.

In another embodiment, a method can be provided for displaying desired and customized information on the label inserted in a label holder means provided on a binder. The method comprises identifying the desired category of sheet material held within the binder, selecting a desired template from a plurality of pre-defined templates available in the identified category, selecting a suitable size of the selected template corresponding to the binder ring size, customizing the information displayed on the selected template, printing the template thereby obtaining a pre-designed and customized label, and inserting the obtained label into the label holder means provided on a binder spine and front flange.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a binder in an open position, in accordance with a preferred embodiment;

FIG. 2 illustrates a binder in a closed position, in accordance with a preferred embodiment;

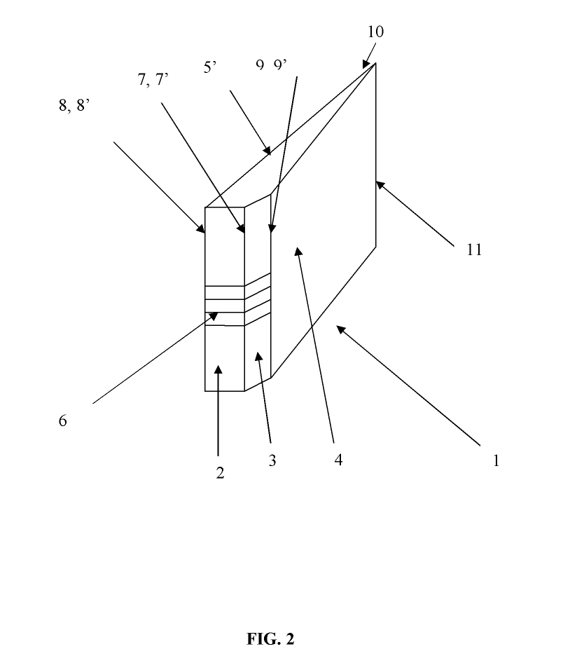

FIG. 3 illustrates a binder with a partial label overlay configuration, which can be implemented in accordance with an alternative embodiment; and

FIG. 4 illustrates a binder with a full label overlay configuration, which can be implemented in accordance with another embodiment.

### DETAILED DESCRIPTION

The particular values and configurations discussed in these non-limiting examples can be varied and are cited merely to illustrate at least one embodiment and are not intended to limit the scope thereof.

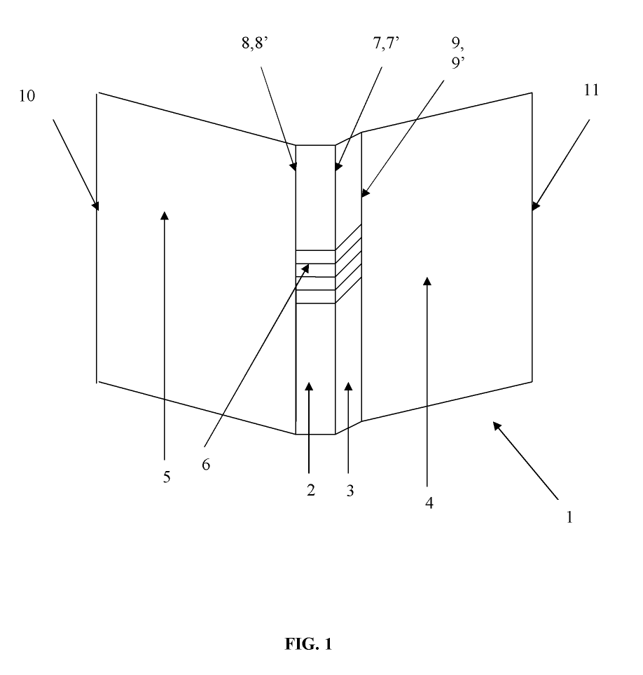

FIG. 1 illustrates a double hinged binder 1 including a spine 2, a front flange 3, a front cover 4, a rear cover 5, a label holder means 6 provided on the spine and a plurality of rings not shown disposed on the internal surface of the rear cover, in accordance with a preferred embodiment. Note that the label holder means can be configured to extend along the length of the spine and completely over area 3 (flange) and area 4 (front cover), depending upon the binder design configuration. The label holder 6 can be configured as a wrap-around label holder and may be implemented in a full-overlay fashion or partial small overlay configuration, depending upon design configurations. The label holder 6 illustrated in FIG. 1 is illustrated as a partial small overlay configuration, but a full-overlay configuration may also be desirable in some implementations.

The spine has an external surface and an internal surface defining a first longitudinal edge 7 and a second longitudinal edge 8. The front flange has a first a first longitudinal edge 7 and a second longitudinal edge 9.

The first longitudinal edge of the front flange is attached to the first longitudinal edge of the spine. The first longitudinal edge 8 of the rear cover is attached to the second longitudinal edge of the spine. The front cover has a first longitudinal edge 9′ and a second longitudinal edge 11. The first longitudinal edge of the front cover is attached to the second longitudinal edge of the front flange while the second longitudinal edge of the front cover is rotatably free.

The rear cover has a first longitudinal edge 8′ and a second longitudinal edge 10. The first longitudinal edge of the rear cover is attached to the second longitudinal edge of the spine while the second longitudinal edge of the rear cover is rotatably free. The label holder means is made up of a predetermined material and is adapted to overlie at least a portion of the binder spine and the front flange. The portion of the label holder means overlying the binder spine is unattached to the external surface of the binder spine at the longitudinal edge 7 thereby defining a display area which is capable of receiving and displaying a label. The label has information displayed thereon.

The internal surface of the rear cover has a plurality of binder rings made up of a predetermined material. The binder rings run through a plurality of holes punched onto sheet material thereby holding the sheets of paper into the binder. The second longitudinal edges of the front and rear covers are rotatable from a first closed position to a second partially open or open position such that the longitudinal edges in the first closed position overlie each other thereby closing the binder. The longitudinal edges of the front and rear covers in the second partially opened or opened position allow access to the sheet material held within the binder.

It has been found that providing a double hinged support to the spine and front cover enables the binders to be made shallower with the spine forming the base. This allows the large capacity binders to be accommodated on the standard 12″ office shelving without hanging over the edges. It has consequently also been found that double hinging the spine with the front cover and flange enables the spine to be made having a narrower width than was previously possible, which enables easier handling of the binder and requires less shelf width thereby promoting space economy.

In a preferred embodiment, the label holder means is adapted to overlie a portion of the front flange without being attached to the spine at longitudinal edge 7. The portion of the label holder overlying the spine thereby defines an enlarged display area comprising the spine and portions of the front flange, which receives and displays various labels. The label inserted within the label holder means appears on the spine as well as on the front flange portion thereof.

In a preferred embodiment, the information displayed on the label includes information identifying the sheet material held within the binder.

In an alternative embodiment, the label holder means can be formed from a predetermined material.

In a further preferred embodiment, the label holder means is composed of PVC. It has been found according to the present invention that use of PVC for the label holder means minimizes the transfer of ink from the label to the back of the PVC forming the label holder means. Accordingly, the label holder means is not permanently marked enabling use of a plurality of successive labels depending upon the encased sheet material. This therefore also avoids the common need felt in the art to replace the label holder means due to permanent marking left over by the previous labels.

The use of a predetermined ring metal for rings disposed on the internal surface of the rear cover results into a quick loading binder. The quick loading binder thus produced allows a user to load paper through the rings more easily.

The size of the binder produced is not considered a limited feature of the disclosed embodiments, but can be typically produced in seven capacities from ⅝″ to 5.0″, depending upon design goals and considerations. It is understood; however, that a person skilled in the art may modify the size of the binder depending upon the size requirements without departing from the scope of the invention.

In another aspect, the present invention can provide a method for displaying desired and customized information on the label inserted in a label holder means provided on a binder. The method comprises identifying the desired category of sheet material held within the binder, selecting a desired template from a plurality of pre-defined templates available in the identified category, selecting a suitable size of the selected template corresponding to the binder ring size, customizing the information displayed on the selected template, printing the template thereby obtaining a pre-designed and customized label, and inserting the obtained label into the label holder means provided on a binder spine.

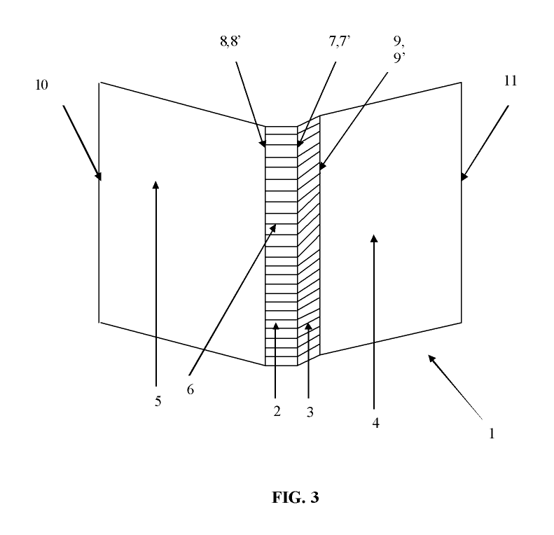

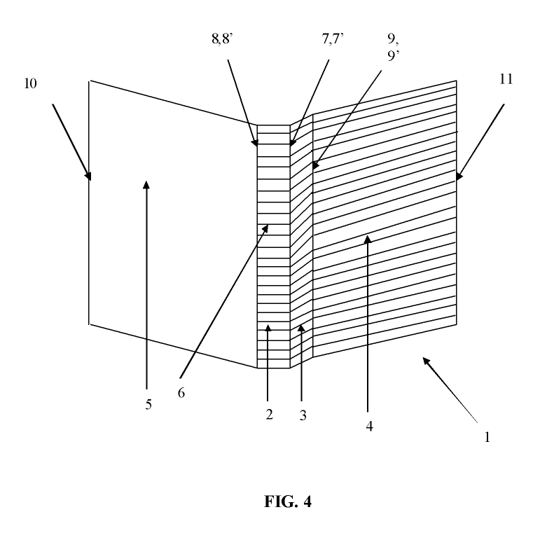

FIG. 3 illustrates a double hinged binder 1 including a spine 2, a front flange 3, a front cover 4, a rear cover 5, a label holder means 6 provided on the spine and a plurality of rings not shown disposed on the internal surface of the rear cover in a partial overlay label configuration, in accordance with an alternative embodiment. FIG. 4 illustrates the double hinged binder 1 depicted in FIG. 3 in a full overlay label configuration, in accordance with another embodiment. Note that in FIGS. 1 and 3-4, identical or similar parts or elements are generally indicated by identical reference numerals. Thus, the same components generally illustrated in FIGS. 1 and 3 also holds generally true for the embodiment disclosed in FIG. 4, the difference being that the label holder means 6 depicted in FIG. 4 is configured in a full-overlay configuration, rather than the partial overlay configuration depicted in FIG. 3. That is, the label holder means 6 depicted in the embodiment of FIG. 4 extends across the front flange 3 and the front cover 4, while the label holder means 6 depicted in FIG. 3 only extends across the front flange 3.

In a preferred embodiment, the steps of selecting a suitable template having a suitable size, customization of the displayed information and thereafter printing the desired template may be carried out by a user over a local area network or a wide area network (e.g., the internet). It will be apparent to a person skilled in the art, however, that such steps could also be carried out by a user at the manufacturer's premises, which shall be understood as being within the scope of the invention described herein. A general methodology for displaying desired and customized information on the label inserted in a label holder means provided on a binder as discussed earlier, can be outlined as follows:
(a) identifying a desired category of sheet material held within the binder;
(b) selecting a desired template from a plurality of pre-defined templates available in the identified category;
(c) selecting a suitable size of the selected template corresponding to the binder ring size;
(d) customizing the information displayed on the selected template;
(e) printing the template thereby obtaining a pre-designed and customized label; and
(f) inserting the obtained label into the label holder means provided on a binder spine and front flange.

The step of selecting a suitable template having a suitable size, customization of the displayed information and thereafter printing the desired template can be carried out by a user over a computer network.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A binder apparatus, comprising:
a double hinged cover;
a binder spine associated with said double hinged cover, wherein said binder spine and said doubled hinged cover allow for a minimal depth in maintaining said binder apparatus on a standard office shelf without extending beyond an edge of said office shelf; and
a spine label holder attached to a back cover side of said binder spine and to a further most side of a front flange of said double hinged cover, while maintaining said binder spine with an unsealed first longitudinal edge of said binder spine apparatus in order to permit a user to easily insert or remove a label into or from said spine label holder, and wherein said spine label holder wraps around a portion of said front cover of said binder apparatus.

2. The apparatus of claim 1 wherein said spine label holder comprises a clear vinyl PVC material developed to minimize transfer of toner ink from an insert to said vinyl PVC material.

3. A double hinged binder apparatus, comprising:
a binder spine having a first longitudinal edge and a second longitudinal edge, said binder spine further having an external surface and an internal surface;
a front flange having a first longitudinal edge and a second longitudinal edge, said first longitudinal edge of said front flange being attached to said first longitudinal edge of said binder spine;
a front cover having a first longitudinal edge and a second longitudinal edge, said first longitudinal edge of said front cover being attached to said second longitudinal edge of said front flange while said second longitudinal edge of said front cover being a rotatable free end;
a rear cover having a first longitudinal edge and a second longitudinal edge, said first longitudinal edge of said rear cover being attached to said second longitudinal edge of said binder spine while said second longitudinal edge of said rear cover being a rotatable free end;
a label holder means made up of predetermined material and adapted to overlie at least a portion of said binder spine and said front flange wherein said portion of said label holder means overlying said binder spine is unattached to said external surface of said binder spine thereby defining a display area capable of receiving and displaying a label having information displayed thereon; and
a plurality of binder rings made up of predetermined material and disposed on said internal surface of said binder rear cover, said binder rings capable of running through holes punched onto sheets material thereby holding said sheets of paper into said binder;
wherein said second longitudinal edges of said front and rear covers are capable of being rotated from a first closed position to a second partially open or open position such that said longitudinal edges in said first closed position overlie each other thereby closing said binder and in said second partially opened or opened position allow access to said sheet material held within said binder.

4. The apparatus of claim 3 wherein said label holder means overlies a substantial portion of said front flange through said binder spine thereby forming an extended display area.

5. The apparatus of claim 3, wherein said label holder means overlies said binder spine only.

6. The apparatus of claim 3 wherein said label holder means is composed of a PVC material developed to minimize transfer of toner ink from said insert to said PVC material.

7. The apparatus of claim 3 wherein said plurality of rings disposed on said internal surface of said rear cover is composed of a quick loading ring metal.

8. The apparatus of claim 3, wherein said information displayed on said label includes information identifying said sheet material held within said binder.

9. A double hinged binder apparatus, comprising:
a binder spine having a first longitudinal edge and a second longitudinal edge, said binder spine further having an external surface and an internal surface;
a front flange having a first longitudinal edge and a second longitudinal edge, said first longitudinal edge of said front flange being attached to said first longitudinal edge of said binder spine;
a front cover having a first longitudinal edge and a second longitudinal edge, said first longitudinal edge of said front cover being attached to said second longitudinal edge of said front flange while said second longitudinal edge of said front cover being a rotatable free end;
a rear cover having a first longitudinal edge and a second longitudinal edge, said first longitudinal edge of said rear cover being attached to said second longitudinal edge of said binder spine while said second longitudinal edge of said rear cover being a rotatable free end;
a label holder means made up of predetermined material and adapted to overlie at least a portion of said binder spine and said front flange wherein said portion of said label holder means overlying said binder spine is unattached to said external surface of said binder spine thereby defining a display area capable of receiving and displaying a label having information displayed thereon; and
a plurality of binder rings made up of predetermined material and disposed on said internal surface of said binder rear cover, said binder rings capable of running through holes punched onto sheets of material thereby holding said sheets of paper into said binder;
wherein said second longitudinal edges of said front and rear covers are capable of being rotated from a first closed position to a second partially open or open position such that said longitudinal edges in said first closed position overlie each other thereby closing said binder and in said second partially opened or opened position allow access to said sheet material held within said binder;
wherein said label holder means overlies a substantial portion of said front flange through said binder spine thereby forming an extended display area.

10. The apparatus of claim 9, wherein said label holder means overlies only said binder spine and said front flange.

11. The apparatus of claim 9 wherein said label holder means is composed of a PVC material developed to minimize transfer of toner ink from said insert to said PVC material.

12. The apparatus of claim 9 wherein said plurality of rings disposed on said internal surface of said rear cover is composed of a quick loading ring metal.

13. The apparatus of claim 9 wherein said information displayed on said label includes information identifying said sheet material held within said binder.

14. The apparatus of claim 9, wherein said label holder means overlies said binder spine, said front flange and said front cover, and wherein said label holder means is composed of a PVC material developed to minimize transfer of toner ink from said insert to said PVC material.

15. The apparatus of claim 9 wherein said label holder means is composed of a PVC material developed to minimize transfer of toner ink from said insert to said PVC material and wherein said information displayed on said label includes information identifying said sheet material held within said binder.

16. A method for displaying desired and customized information on said label inserted in a label holder means provided on a binder, said method comprising:
(g) identifying a desired category of sheet material held within said binder;
(h) selecting a desired template from a plurality of pre-defined templates available in said identified category;
(i) selecting a suitable size of said selected template corresponding to said binder ring size;
(j) customizing said information displayed on said selected template;
(k) printing said template thereby obtaining a pre-designed and customized label; and
(l) inserting said obtained label into said label holder means provided on a binder spine and front flange.

17. The method of claim 16 the steps of:
selecting a suitable template having a suitable size;
customizing said displayed information; and
thereafter rendering said desired template by a user via a computer network.

18. The method of claim 17 wherein said computer network comprises the Internet.
